(19) United States
(12) Patent Application Publication
(10) Pub. No.: US 2024/0005232 A1
(43) Pub. Date: Jan. 4, 2024

(54) Generating Execution Protocols for Performing Standard Operating Procedures in Industrial Plants

(71) Applicant: ABB Schweiz AG, Baden (CH)

(72) Inventors: Benedikt Schmidt, Heidelberg (DE); Jens Doppelhamer, Ladenburg (DE); Pablo Rodriguez, Ilvesheim (DE); Benjamin Kloepper, Mannheim (DE); Reuben Borrison, Bruehl (DE); Marcel Dix, Allensbach (DE); Hadil Abukwaik, Weinheim (DE); Arzam Muzaffar Kotriwala, Ladenburg (DE); Sylvia Maczey, Hirschberg (DE); Dawid Ziobro, Västerås (SE); Simon Hallstadius Linge, Västerås (SE); Marco Gaertler, Dossenheim (DE); Divyasheel Sharma, Bangalore (IN); Chandrika K R, Bangalore (IN); Gayathri Gopalakrishnan, Solna (SE); Matthias Berning, Worms (DE)

(73) Assignee: ABB Schweiz AG, Baden (CH)

(21) Appl. No.: 18/448,535

(22) Filed: Aug. 11, 2023

Related U.S. Application Data
(63) Continuation of application No. PCT/EP2022/050400, filed on Jan. 11, 2022.

(30) Foreign Application Priority Data
Feb. 12, 2021 (EP) 21156885.2

(51) Int. Cl. G06Q 10/0631

(52) U.S. Cl. CPC G06Q 10/063112; G06Q 10/06312

(57) ABSTRACT

A method for generating and/or augmenting an execution protocol for an SOP in an industrial plant includes providing at least one SOP of the plant, which includes a plurality of steps; providing measurement data; for each step of the SOP, determining from the measurement data a subset of the measurement data that is indicative of actions performed for the purpose of executing this particular step of the SOP; and aggregating the subset of the measurement data determined for each step of the SOP into at least one instruction for executing this particular step of the SOP, wherein this instruction is part of the sought protocol.

### CROSS-REFERENCE TO RELATED APPLICATIONS

The instant application claims priority to International Patent Application No. PCT/EP2022/050400, filed Jan. 11, 2022, and to European Patent Application No. 21156885.2, filed Feb. 12, 2021, each of which is incorporated herein in its entirety by reference.

### FIELD OF THE DISCLOSURE

The present disclosure generally relates to facilitating the execution of not fully automatable standard operating procedures (SOP) in industrial plants.

### BACKGROUND OF THE INVENTION

For many safety-critical industrial plants, especially chemical plants, certain tasks are to be performed according to standard operating procedures, SOPs. These SOPs have been devised to ensure safe and reliable operation of the plant. For example, an SOP may specify what exactly to do in order to start the plant up, to shut the plant down, or to perform maintenance work on the plant or any part thereof. These and other tasks for which SOPs are mandated are frequently not fully automatable; rather, they require the enlisting of one or more human workers who have to execute the SOPs. The SOPs are frequently part of a certification or other licensing of plant operation, so adherence to SOPs is crucial.

EP 1 413 937 A1 discloses a control system for controlling an apparatus and/or a process based on a finite state machine. Information made available to an operator is enhanced by a graphical representation of the finite state machine on a display. The graphical representation comprises at least two states and at least one allowed transition between these two states.

### BRIEF SUMMARY OF THE INVENTION

Embodiments of the present disclosure assist the execution of SOPs in industrial plants by computer even though this execution itself is not fully automatable. The disclosure describes, in a general aspect, a first computer-implemented method for generating an execution protocol for at least one SOP, and a second computer-implemented method for orchestrating the execution of an SOP that exploits the so-generated execution protocol.

In a more particular aspect, the present disclosure describes a computer-implemented method for generating and/or augmenting an execution protocol for at least one standard operating procedure, SOP, in an industrial plant.

Herein, the term “protocol” is not to be construed limiting in the sense that this is the only way to execute the SOP and everything has to be done exactly according to this protocol. Rather, instructions in the protocol may allow some degree of freedom, such as “close all valves leading to a particular vessel” without specifying in which order the valves are to be closed. Also, there may be multiple distinct ways to execute the SOP. This might even be desirable from a reliability point of view. If the only way forward presumes the availability of a certain piece of equipment, and this piece of equipment fails, then this is a single point of failure, and execution of the SOP cannot continue. But if there is an alternative way of accomplishing the same result, using other pieces of equipment, there is no single point of failure anymore.

That is, the term “protocol” is not to be construed limiting as in “communication protocol”. Rather, the meaning of the term “protocol” in the context of the present invention is very similar to that of the term “recipe”, namely a sequence of instructions that allows to achieve a particular goal. Not incidentally, the term “execution protocol” is a well-known term in the English language for a detailed description how to inflict capital punishment on a convict.

The method starts from at least one SOP of the plant that is provided. The SOP comprises a plurality of steps. Herein, the term “step” is not to be construed limiting in the sense that there is only one single sequence of steps leading from start to finish of the SOP. Rather, one or more steps in the SOP may optional, and at any point during execution of the SOP, there may be a choice between two or more alternative steps.

In the course of the method, measurement data that has been acquired during multiple executions of the at least one SOP is provided. This measurement data is indicative of actions performed in the plant that modify the state and/or the behavior of the plant or any part thereof for executing the SOP.

Examples of such measurement data include: log data that is indicative of the inputting of at least one instruction to modify the behavior of the plant or any part thereof into a distributed control system of the plant; measurement data delivered by at least one field device that is in direct relationship with an industrial process executed by the plant; and monitoring data that is indicative of the location, and/or of the behavior, of at least one worker who participates in executing the SOP.

For each step of the SOP, from this measurement data, a subset of the measurement data that is indicative of actions performed for the purpose of executing this particular step of the SOP is determined. That is, the measurement data may be split according to the steps of the SOP to which they pertain, and measurement data that is not relevant for execution of the SOP at all may be ignored.

The subset of the measurement data determined for each step of the SOP is aggregated into at least one instruction for executing this particular step of the SOP. This instruction is part of the sought protocol for executing the SOP as a whole. In particular, measurement data may be aggregated via the action that they represent, and this action may link the measurement data to one or more instructions. For example, an instruction may relate to performing one or more actions. The other way round, given one or more actions, it may, for example, be looked up in a predetermined correspondence which one or more instructions need to be carried out for performing the one or more actions.

While SOPs are highly relevant for the plant operation, they are often specified in an early stage of the plant on a very abstract level. Therefore, they do not always contain later adjustments or the knowledge of people who have much experience with this specific plant. Much of this knowledge is hard to put in writing. Therefore, it is often only present in the brains of the workers who execute the SOP. Also, the abstract specification of the SOP may be open to interpretation to some degree.

For example, if the SOP specifies to open a valve “slowly”, this does not specify unambiguously whether the opening is to be performed at a constant slow speed, or whether the opening is to start extremely slowly and speed up soon. Also, every worker may have a different notion of the concrete speed to which “slowly” refers.

Also, the new or amended protocol for executing the SOP contains richer detail that is particularly useful for aiding novices who have little experience with the plant. For example, if it has been logged that a worker who executes a particular step of the SOP always walks to a certain place within the plant, then the protocol for executing the SOP, which might previously just have mentioned a certain piece of equipment by name or by a relative term like “leftmost pump”, will now contain a concrete location on the plant floor that cannot be mistaken for anything else. By contrast, the relative term “leftmost pump” might lead a novice who enters the building through the back door, rather than through the front door, to the wrong place.

The present invention does not strive for an improvement of the SOP itself. The SOP is taken as a given. In the course of a method, a recipe is extracted from operator actions, so as to facilitate execution of the given SOP. That is, knowledge for performing the SOP that may be present only in the brain of the operator may now be put in writing for everybody else to use.

An SOP may also refer to a technical location, e.g., a tag indicating a specific position, that can be hard to find. For example, the position indicated on the tag may need to be translated into a physical location in the plant by means of a piping and instrumentation diagram at least by a novice worker. But after having been there for a number of times, an experienced worker will remember the physical location without having to consult the diagram again.

Log data may, for example, be obtained from a plant historian that captures an audit trail of plant operation and sensor values. For example, the log data may specifically be indicative of one or more of: the setting of a new set-point for a low-level controller in the plant; the opening or closing of at least one valve in the plant; the starting or stopping of at least one piece of equipment in the plant; and the commanding of any other actuator that modifies the state or behavior of the plant or any part thereof.

Monitoring data that is indicative of the location, and/or of the behavior, of at least one worker who participates in executing the SOP may, for example, comprise one or more of: at least one video stream that shows at least one worker who participates in executing the SOP, and/or is captured with a camera worn by this worker; data that is indicative of a gaze direction of at least one worker who participates in executing the SOP; radio or audio recordings of the voice of at least one worker who participates in executing the SOP; and interactions, such as cursor movements and menu selections, between at least one worker who participates in executing the SOP and a human-machine interface of the distributed control system of the plant.

For example, a factory floor may be monitored by video surveillance to track where the worker is going in the plant. The location of the worker may also be obtained from a video stream that is captured with a camera worn by the worker. The latter, as well as a gaze direction of the worker, may also be used to monitor to what the worker is actually paying attention.

Radio or audio recordings of the voice of the worker may yield information as to which communication between this worker and other workers in the plant is necessary for executing the step of the SOP. For example, if the SOP for maintenance of a certain piece of equipment mandates disconnecting this equipment from the mains and securing it against reconnection, this may entail communicating with a central control room by two-way radio in order to have the power disconnected and the respective switch tagged and locked out.

Interactions between the worker and a human-machine interface may yield information as to which information a worker is looking up in this interface. For example, the SOP may specify that before a certain vessel is opened, the temperature and/or pressure inside must be verified. The interactions with the human-machine interface may augment the specification in the SOP with the information where the required information may be found.

The determining of respective actions “for performing each particular step of the SOP” means that given each step of the SOP, it is determined which manual actions are performed for the purpose of this particular step. The manual actions, and the measurement data that are indicative of these manual actions, are grouped according to the given SOP steps. Thus, the process is still governed by the original SOP that is neither amended nor overridden.

In a particularly advantageous embodiment, the determining of a subset of the measurement data that relates to a step of the SOP comprises filtering, from the measurement data, a portion that relates to one or more of: a timeslot in which the step of the SOP was performed; equipment that is relevant for executing of the step of the SOP; a location in the plant that is relevant for executing the step of the SOP; and a worker who is assigned a role of participating in executing the step of the SOP; and components of graphical user interfaces which have high relevance for the execution.

That is, a “fuzzy alignment” process may be performed in order to cluster measurement data that is relevant to particular SOP steps, so as to drop data that is not related to execution of the SOP and to map the remaining data to SOP steps.

Equipment that is relevant for executing a step of the SOP may, for example, be extracted from the SOP description by suitable heuristics. Likewise, roles of workers who need to participate in executing the steps of the SOP may be extracted from the SOP description as well. Timeslots in which steps of the SOP was performed may be extracted from the measurement data itself in combination with the SOP description. For example, completion of certain steps of the SOP may manifest itself in some signature in the measurement data, such as records of the closing of a valve or of a flow dropping to zero.

Each single filtering criterion applied to the measurement data may be considered to be a “weak learner” that gives some notion, but no unambiguous decision, about the relevancy of a record of measurement data for a particular step of the SOP. But the combination of multiple such “weak learners” may provide for a much more accurate assessment of whether a certain record of measurement data is relevant for executing a particular step of an SOP. Therefore, in a particularly advantageous embodiment, the measurement data is filtered according to multiple criteria. A relevancy score is assigned to each record of measurement data. This relevancy score increases with the number of criteria that this particular record of measurement data fulfils. A record of measurement data may then be included in the subset that relates to a particular step of the SOP in response to the relevancy score exceeding a predetermined threshold.

### BRIEF DESCRIPTION OF THE SEVERAL VIEWS OF THE DRAWING(S)

FIG. 1 is a flowchart for a method for generating and/or augmenting an execution protocol for an SOP, in accordance with the disclosure.

FIG. 2 is a diagram of an execution protocol in accordance with the disclosure.

FIG. 3 is a flowchart for a method for orchestrating the execution of an SOP in accordance with the disclosure.

### DETAILED DESCRIPTION OF THE INVENTION

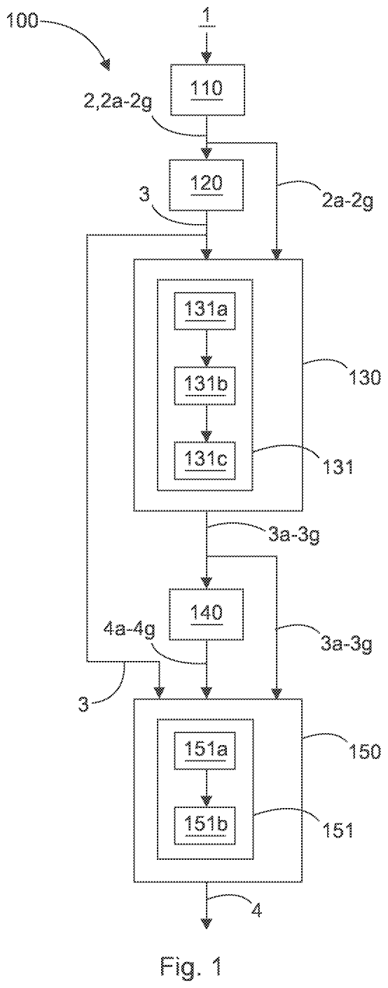

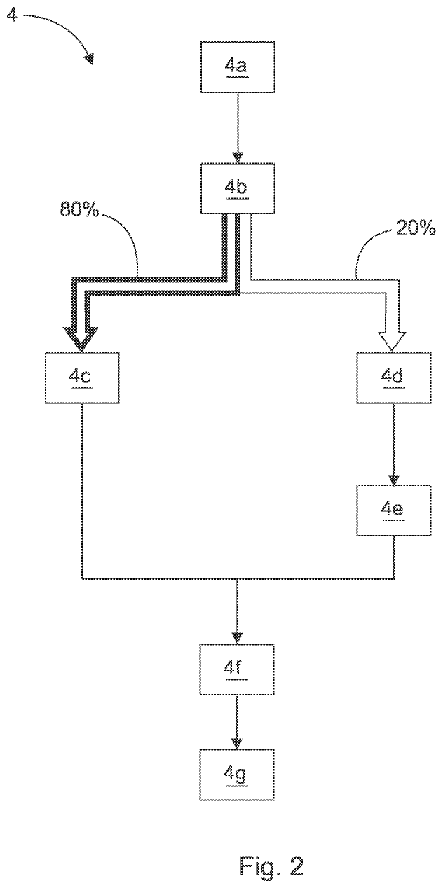

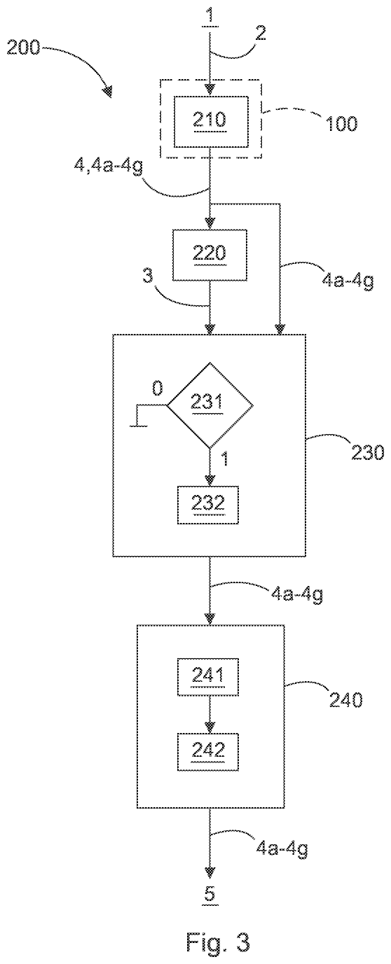

FIG. 1 shows an exemplary embodiment of a method 100 for generating and/or augmenting an execution protocol 4 for an SOP 2; FIG. 2 shows an exemplary execution protocol 4 generated by the method 100; and FIG. 3 shows an exemplary embodiment of a method 200 for orchestrating the execution of an SOP 2.

FIG. 1 is a schematic flow chart of an embodiment of the method 100 for generating and/or augmenting an execution protocol 4 for an SOP 2. In step 110, at least one SOP 2 that comprises a plurality of steps 2a-2g is provided. In step 120, measurement data 3 is provided. This measurement data 3 has been acquired during multiple executions of the at least one SOP 2. It is indicative of actions performed in the plant 1 that modify the state and/or the behavior of the plant 1 or any part thereof for the purpose of executing the SOP 2.

In step 130, for each step 2a-2g of the SOP 2, a subset 3a-3g of the measurement data 3 that is indicative of actions performed for the purpose of executing this particular step 2a-2g of the SOP is determined.

According to block 131, this determining 130 may specifically comprise “fuzzy filtering” from the measurement data according to one or more criteria, each of which may be a “weak learner”. In particular, according to block 131a, the measurement data 3 may be filtered according to multiple criteria. According to block 131b, each record of measurement data 3 may be assigned a relevancy score, which increases with the number of criteria that this particular record of measurement data 3 fulfils. In response to this relevancy score exceeding a predetermined threshold, a record of measurement data 3 may be included in the subset 3a-3g according to block 131c.

In step 140, the subset 3a-3g of the measurement data 3 determined for each step 2a-2g of the SOP 2 is aggregated into at least one instruction 4a-4g for executing this particular step 2a-2g of the SOP. This instruction 4a-4g is part of the sought protocol 4.

In step 150, a directed sequence of actions that results in execution of the complete SOP 2 may be determined as the sought protocol 4 from the measurement data 3, from the subsets 3a-3g, and/or from the instructions 4a-4g. The actions may correspond to the instructions 4a-5g, but one or more of the instructions 4a-4g may also be broken down into more granular sub-actions.

According to block 151, multiple sequences of actions that result in execution of the complete SOP 2 may be combined into a directed graph of these actions. In particular, according to block 151a, to each edge connecting a first action and a subsequent second action, a probability that the second action will be executed given the first action may be assigned. According to block 151b, a path through the graph that selects, at each action that is connected to two or more possible next actions, the next action with the higher probability may be determined as an execution protocol 4 for the SOP 2.

FIG. 2 is an example of an execution protocol 4 for an SOP 2. The execution protocol 4 is in the form of a directed graph and comprises instructions 4a-4g that correspond to steps 2a-2g of the SOP 2. After the second step 4b, there are two options. The first option is to carry out instruction 4c. The second option is to carry out the combination of instructions 4d and 4e. Both options arrive at the same result that puts the plant 1 in a state where the next instruction 4f, and then finally instruction 4g, may be carried out.

For example, instruction 4c may relate to a straight-forward way of achieving the needed result, whereas the combination of instructions 4d and 4e may relate to an indirect way of achieving the same result. Therefore, as shown in FIG. 2, according to the measurement data 3, the direct way is followed with a probability of 80%, whereas the indirect way is followed with a probability of 20%. The indirect way may, for example, be useful as a backup in case a piece of equipment that is necessary for the direct way is not available.

FIG. 3 is a schematic flow chart of an exemplary embodiment of the method 200 for orchestrating the execution of at least one SOP 2. In step 210, at least one execution protocol 4 with instructions 4a-4g that has been generated and/or augmented by the method 100 described above. In step 220, measurement data 3 is obtained. This measurement data 3 is indicative of at least one activity that at least one worker 5 is performing. The worker 5 is to participate in executing the SOP 2.

In step 230, based at least in part on the measurement data 3, at least one instruction 4a-5g that the worker 5 is to carry out is selected from the execution protocol 4. Herein, according to block 231, it may be determined whether the worker 5 has already carried out an instruction 4a-4g and/or is already at a location where this instruction 4a-4g is to be carried out. If this is the case (truth value 1), according to block 232, the instruction 4a-4g, and/or a direction to navigate to the location where this instruction 4a-4g is to be carried out, may be suppressed.

In step 240, the instruction 4a-4g is communicated to the worker 5. Herein, according to block 241, a skill level of the worker 5 may be determined based on current and/or past measurement data 3. According to block 242, the level of detail of the instruction may be adjusted based on this skill level.

In a further advantageous embodiment, the method further comprises determining, from the measurement data, from the already determined subsets, and/or from the already determined instructions, at least one directed sequence of actions that results in execution of the complete SOP as the sought protocol. This means that the method can not only fill in an execution protocol for the SOP with more details, but also elucidate one or more ways to traverse the SOP as a whole. The SOP itself may not be clear on the order in which certain actions need to be performed. In particular, the method may attach one single graph of actions that is derived from the measurements to the SOP, but there may be multiple ways to traverse this graph.

For example, the SOP may just call for the powering on of a machine, and this machine may be controlled by a separate control unit. There are now two ways to power on the machine: first power on the control unit and then power on the machine, or first power on the machine and then power on the control unit. On the face of it, there are reasons for both ways. Powering on the control unit first ensures that the machine will not have power without being under the control of the control unit. Powering on the machine first ensures that the control unit will not be confused because the machine is “missing” when the control unit is starting up. From the measurement data, the method may learn which of the two reasons is deemed to be more compelling in the context of this particular plant. Also, instructions and/or more detailed support communicated to a worker may to some extent be dynamic as a result of traversing the action graph differently. For example, no matter whether the worker is powering up the machine or the control unit first, he may always receive dynamic support for operating the piece of the equipment that he has chosen to start up first.

There are more examples of how an SOP can be executed on multiple different paths. The existence of multiple such paths may even be desirable for safety reasons. For example, relieving the pressure inside a vessel might normally be performed by an automatically controlled valve, but in case this valve is stuck or there is a power failure, it may become necessary to relieve the pressure using a manually operated valve.

Therefore, in a further advantageous embodiment, multiple sequences of actions that result in execution of the complete SOP are combined into a directed graph of these actions. In this manner, the method can learn all available alternatives for proceeding further in the SOP. This includes alternatives that were not foreseen at the time of establishing of the SOP. For example, in case of a malfunction of a certain piece of equipment, plant personnel may find a creative way of substituting the missing function by repurposing other equipment.

For example, if it is not possible to remove a load of acid from a reaction vessel because a subsequent vessel where the acid is to be neutralized is springing a leak, a different port of the reaction vessel might be repurposed to transport the acid to another vessel somewhere else in the plant, so it can be neutralized there and safely discharged.

Preferably, in this directed graph, each edge connecting a first action and a subsequent second action is assigned a probability that the second action will be executed given the first action, based on the provided measurement data. This makes it immediately clear what the preferred way to proceed further in the SOP and what is an auxiliary way.

Therefore, in a further advantageous embodiment, a path through the graph that selects, at each action that is connected to two or more possible next actions, the next action with the higher probability, is determined as an execution protocol for the SOP. In this manner, if different ways to execute certain steps of the SOP have been used previously by different workers, one standard way may be produced that should be used unless there is a compelling reason (such as a malfunction) for deviating from this. Having one standard way increases the probability that the SOP will be performed correctly because the potential for errors is reduced. For example, if a first worker who performs the SOP the one way watches a second worker performing a particular step differently, he may adopt this behavior even though this is wrong in the context of the path that the first worker is following. I.e., the adoption of multiple different execution protocols by different workers may give rise to an intermixing of the different execution protocols that violates the SOP.

The invention also provides a computer-implemented method for orchestrating the execution of at least one standard operating procedure, SOP, in an industrial plant. In the course of this method, at least one execution protocol for the SOP that has been generated and/or augmented by the method described before is provided. This generating and/or augmenting may have been performed by the same entity that is orchestrating the execution of the SOP, or it may have been performed at least in part by a different entity. For example, a company who owns a plant where the SOP is to be performed might enlist the help of another company who provides the generation of the execution protocol from the measurement data as a service.

Measurement data is obtained that is indicative of at least one activity that at least one worker who is to participate in executing the SOP is performing. For example, this measurement data may be indicative of the location or gaze direction of the worker, or of what this worker is presently seeing. The measurement data may also, for example, relate to a state of a plant or any part thereof. For example, if the worker has already opened or closed a valve that is to be opened or closed, the measurement data may so indicate.

Based at least in part on the measurement data, at least one instruction that this worker is to carry out is selected from the execution protocol. The instruction to perform the at least one action is communicated to the worker. This communicating may be performed in any suitable manner. For example, the information may be overlaid onto an augmented reality display that the worker is using. For example, the worker may be guided to a location where the action is to be performed. The equipment that the worker should handle may then be highlighted in this augmented reality display. When the worker is interacting with the plant via a human-machine interface of a distributed control system,

In a particularly advantageous embodiment, in the course of selecting an instruction, it is determined whether the worker has already carried out an instruction, and/or is already at a location where this instruction is to be carried out. If this is the case, the instruction, and/or a direction to navigate to the location where this instruction is to be carried out, is suppressed. In this manner, the worker is not overloaded with unnecessary information. Such unnecessary information that is safe to ignore might cause the worker to ignore other, more safety relevant information as well.

Likewise, in a further advantageous embodiment, a skill level of the worker is determined based on current and/or past measurement data. The level of detail of the instruction is based on this skill level. For example, a worker who is already familiar with the plant might only need the instruction to go to a piece of equipment with a particular name or other label, while a novice worker might step-by-step instructions how to find that piece of equipment. For example, if a worker has always gone to the right place when instructed to go to a particular piece of equipment, the level of detail of the instructions may gradually decrease.

The computer implementation of the methods described above implies that the methods may be embodied in a computer program. The invention therefore also provides a computer program with machine-readable instructions that, when executed by one or more computers, cause the one or more computers to perform one of the methods described above. The invention also provides a non-transitory machine-readable storage medium, and/or a download product, with the computer program. A download product is a product that may be sold in an online shop for immediate fulfillment by download. The invention also provides one or more computers with the computer program, and/or with the non-transitory machine-readable storage medium and/or download product.

### LIST OF REFERENCE SIGNS

1 industrial plant
2 standard operating procedure, SOP
2a-2g steps of SOP 2
3 measurement data
3a-3g subset of measurement data corresponding to steps 2a-2g
4 execution protocol for SOP 2
4a-4g instructions in execution protocol 4
5 worker
100 method for generating and/or augmenting execution protocol 4
110 providing SOP 2
120 providing measurement data 3
130 determining subsets 3a-3g of measurement data 3 for steps 2a-2g
131 fuzzy filtering of measurement data 3
131a filtering according to multiple criteria
131b assigning relevancy to measurement data 3
131c considering measurement data 3 based on relevancy
140 aggregating subsets 3a-3g into instructions 4a-4g
150 determining directed sequence of actions
151 producing directed graph of actions
151a assigning probabilities to edges
151b determining path with maximum probabilities
200 method for orchestrating execution of SOP 2
210 providing execution protocol 4
220 obtaining measurement data 3
230 selecting instruction 4a-4g
231 determining whether instruction 4a-4g carried out, location reached
232 suppressing instruction 4a-4g
240 communicating instruction 4a-4g to worker 5
241 determining skill level of worker 5
242 adjusting level of detail based on skill level

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for generating and/or augmenting an execution protocol for at least one standard operating procedure (SOP) in an industrial plant, comprising:
providing at least one SOP of the plant, said SOP comprising a plurality of steps;
providing measurement data that has been acquired during multiple executions of the at least one SOP and is indicative of actions performed in the plant that modify the state and/or the behavior of the plant or any part thereof for the purpose of executing the SOP;
for each step of the SOP, determining, from the measurement data, a subset of the measurement data that is indicative of actions performed for the purpose of executing this particular step of the SOP; and
aggregating the subset of the measurement data determined for each step of the SOP into at least one instruction for executing this particular step of the SOP, wherein this instruction is part of the sought protocol.

2. The method of claim 1, wherein the measurement data comprises one or more of:
log data that is indicative of the inputting of at least one instruction to modify the behavior of the plant or any part thereof into a distributed control system of the plant;
measurement data delivered by at least one field device that is in direct relationship with an industrial process executed by the plant; and
monitoring data that is indicative of the location, and/or of the behavior, of at least one worker who participates in executing the SOP.

3. The method of claim 2, wherein the log data specifically is indicative of one or more of:
setting of a new set-point for a low-level controller in the plant;
opening or closing of at least one valve in the plant;
starting or stopping of at least one piece of equipment in the plant; and
commanding of any other actuator that modifies the state or behavior of the plant or any part thereof.

4. The method of claim 2, wherein the monitoring data comprises one or more of:
at least one video stream that shows at least one worker who participates in executing the SOP, and/or is captured with a camera worn by this worker;
data that is indicative of a gaze direction of at least one worker who participates in executing the SOP;
radio or audio recordings of the voice of at least one worker who participates in executing the SOP; and
interactions between at least one worker who participates in executing the SOP and a human-machine interface of the distributed control system of the plant 1).

5. The method of claim 1, wherein the determining of a subset of the measurement data that relates to a step of the SOP specifically comprises filtering, from the measurement data, a portion that relates to one or more of:
a timeslot in which the step of the SOP was performed;
equipment that is relevant for executing of the step of the SOP;
a location in the plant that is relevant for executing the step of the SOP;
a worker who is assigned a role of participating in executing the step of the SOP; and
components of graphical user interfaces which have high relevance for the execution.

6. The method of claim 5, further comprising:
filtering the measurement data according to multiple criteria;
assigning to each record of measurement data a relevancy score, wherein the relevancy score increases with the number of criteria that this particular record of measurement data fulfils; and
including a record of measurement data in the subset in response to the relevancy score exceeding a predetermined threshold.

7. The method of claim 1, further comprising determining from the measurement data from the subsets and/or from the instructions at least one directed sequence of actions that results in execution of the complete SOP as the sought protocol.

8. The method of claim 7, further comprising combining multiple sequences of actions that result in execution of the complete SOP into a directed graph of these actions.

9. The method of claim 8, further comprising assigning to each edge connecting a first action and a subsequent second action, based on the provided measurement data a probability that the second action will be executed given the first action.

10. The method of claim 9, further comprising determining as an execution protocol for the SOP a path through the graph that selects, at each action that is connected to two or more possible next actions, the next action with the higher probability.

11. A computer-implemented method for orchestrating the execution of at least one standard operating procedure (SOP) in an industrial plant, comprising:
providing at least one execution protocol for the SOP that has been generated and/or augmented;
obtaining measurement data that is indicative of at least one activity that at least one worker who participates in executing the SOP is performing;
selecting, based at least in part on this measurement data, at least one instruction that this worker carries out from the execution protocol; and
communicating the instruction to the worker.

12. The method of claim 11, wherein the selecting at least one instruction comprises determining whether the worker has already carried out an instruction and/or is already at a location where this instruction is to be carried out; and when this is the case, suppressing this instruction, and/or a direction to navigate to the location where this instruction is to be carried out.

13. The method of claim 11, wherein the communicating the instruction comprises determining, based on current and/or past measurement data, a skill level of the worker, and adjusting a level of detail of the instruction based on the skill level.
